(19) United States
(12) Patent Application Publication
(10) Pub. No.: US 2007/0049281 A1
(43) Pub. Date: Mar. 1, 2007

(54) METHOD AND APPARATUS FOR DUAL MODE MOBILE STATION CALL DELIVERY

(75) Inventors: Bonnie Chen, DeSoto, TX (US); Thomas G. Hallin, Erie, CO (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/464,302

(22) Filed: Aug. 14, 2006

Related U.S. Application Data
(60) Provisional application No. 60/713,143, filed on Aug. 31, 2005.

(51) Int. Cl. H04Q 7/20

(52) U.S. Cl. 455/445

(57) ABSTRACT

A method and apparatus for routing a call to a dual mode mobile station (102) when the dual mode mobile station is in one of a plurality of domains (104, 106) is described. If the mobile station (102) is compatible with the domain (104, 106) in which the mobile station has coverage, then the call is delivered to the domain (104, 106) in which the mobile station has coverage. If the mobile station is in a first domain (102), is registered in a second domain (104) and there is no coverage in the second domain (106), then the call may fail in the first domain (104). If the mobile station is not in the first domain (104), is registered in the second domain (106) and there is coverage in the second domain (106), then the call is delivered to the second domain (106).

### FIELD OF THE INVENTION

The present invention relates generally to the routing of calls and, in particular, to the routing of calls to dual mode mobile stations when the mobile stations are in one of two different domains.

### BACKGROUND

Dual mode mobile stations are capable of working in at least two different domains. A first domain includes circuit switch wireless communication network, such as 2^{nd} generation global system for mobile communication networks (GSM) and code division multiple access communication networks (CDMA.) The second domain includes 3^{rd} generation wireless communications such as Internet Protocol wireless communication networks (IP), wireless local area networks (WLAN), 3GPP standard networks and cable networks.

While there are many issues confronting the dual mode handsets that handle calls in both 2G and 3G networks, one issue relates to voice call continuity between circuit switch and Internet Protocol Multimedia Subsystem networks (IMS), such as IMS via WLANs, that requires registration in dual domains, i.e. both circuit switch and IP Network. In other words, the issue relates to how a call will be routed (a) when a mobile station is attached to circuit switch network or is IMS registered for the IP network and (b) when the mobile station has both circuit switch and IP network coverage. How a call will be routed in the numerous various scenarios, to be explained below, can depend on network conditions, operator policies and preferences, mobile station configurations and user preferences.

It is known as a part of the prior art that when a user is active in a circuit switch call, the mobile station needs to provide a constant pulse, or heart beat like signal, to the call continuity control function (CCCF), which is a wireless core network logical entity that performs the call continuity between the domains. The pulse from the mobile station informs the CCCF that the mobile station is in the circuit switch domain or in the IP network. Since the mobile station is in the circuit switch domain or IP network, subsequent calls to the mobile station should be delivered to in the circuit switch or IP network, respectively. This method has many drawbacks, such as battery consumption, network resources needing to periodically send SIP messages from the mobile station to the CCCF, and there being no guaranty that the SIP messages are received by the CCCF.

Also in the prior art, a mobile station was only registered in one domain or the other domain. The mobile station was not registered in both domains simultaneously. Now, however, the mobile station can be registered at the same time in both domains, e.g. circuit switch and IP network, and the network and phone must determine where, how and in which domain to deliver a call such as in a cellular network or a voice over Internet Protocol (VoIP) network. In view of the foregoing, there is a need to have an efficient method and algorithm to determine the call delivery based on the operator policies and the user preference.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of a block diagram of a dual mode mobile station operating in one of at least two domains in accordance with some embodiments of the invention.

FIG. 1a is a block diagram of a dual mode mobile station used in accordance with the principles of the present invention.

FIG. 2 is a flow chart of the operation of dual mode mobile station when the call is circuit switch domain triggered.

FIG. 3 is a flow chart of the operation of a dual mode mobile station when the call is IP network triggered.

FIG. 4 is a call flow diagram of the operation of a dual mode mobile station when the mobile station is IMS registered and is routed in the IP network.

FIG. 5 is a call flow diagram of the operation of a dual mode mobile station when the mobile station is circuit switch based and the call is routed in the IP network.

FIG. 6 is a call flow diagram of the operation of a dual mode mobile station when the mobile station is IMS registered and is in the circuit switch domain.

FIG. 7 is a call flow diagram of the operation of a dual mode mobile station when the mobile station is circuit switch based and the call is registered in the circuit switch domain.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to the routing of calls to dual mode mobile stations that can have multiple registrations in different domains such as a circuit switch domain and an Internet Protocol (IP) network. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of routing calls to dual mode mobile stations described herein. The non-processor circuits may include, but are not limited to, a radio receiver, a radio transmitter, signal drivers, clock circuits, power source circuits, and user input devices. As such, these functions may be interpreted as steps of a method to perform the routing of calls to dual mode mobiles stations in a circuit switch domain or an IP network. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The present invention provides a method and apparatus for efficient call delivery when the dual mode mobile station is registered in both a circuit switch domain and an IP network. The present invention will take into account a number of different factors including mobile communication operator policies and mobile station user preferences. When the dual mode mobile station is dual registered and the IMS is set as the default call delivery domain, the call delivery probability is more efficient. The recommended default for voice continuity is to set IMS as the default call delivery setting. Nonetheless, the present invention takes into account routing of the call when the mobile station is circuit switch default and when the IP network is not available.

The present invention determines how to route a call to the dual mode mobile station depending on in which domain the mobile station is, how the mobile station is attached and the coverage that is available for the mobile station. If the mobile station is compatible with the domain in which the mobile station has coverage, being a domain where the call can be connected, then the call is delivered in the domain in which the mobile station has coverage. If the mobile station is in a first domain but is registered in a second domain and there is no coverage in the second domain, then the call may fail in the first domain and the call may be redirected. If the mobile station is not in the first domain and is registered in the second domain and there is coverage in the second domain, then the call is delivered to the mobile station in the second domain. If the mobile station is not in the first domain and is not registered in the second domain, then the call may fail in the first domain and the second domain.

More particularly, the routing of a call to a dual mode mobile station wherein the dual mode mobile station is in a circuit switch domain and can be registered in an Internet Protocol network is determined. The call is delivered via the circuit switch domain when the mobile station is attached to the circuit switch domain and is in circuit switch coverage such that a call can be connected in the circuit switch domain. On the other hand, the call is delivered via the Internet Protocol network if the mobile station is registered with an Internet Protocol Multimedia Subsystem and is in the Internet Protocol network. The method of routing a call to a dual mode mobile station wherein the mobile station is in an Internet Protocol network is also determined. The call is delivered to the Internet Protocol network if there mobile station is registered with an Internet Protocol Multimedia Subsystem. The call is delivered a circuit switch domain if the mobile station is registered with an Internet Protocol Multimedia Subsystem and the mobile station is in the circuit switch domain.

In addition, the call is delivered to a circuit switch domain if the mobile station is not registered with the Internet Protocol Multimedia Subsystem and the mobile station is in the circuit switch domain. For a subsequent call, the call is delivered to the circuit switch domain after the call is delivered to the circuit switch domain if the mobile station is registered with the Internet Protocol Multimedia Subsystem and the mobile station is in the circuit switch domain when the mobile station is in the circuit switch domain. A subsequent call can be delivered to the Internet Protocol network if after the call is delivered to the circuit switch domain if the mobile station is registered with an Internet Protocol Multimedia Subsystem and the mobile station is in the circuit switch domain when the mobile station moves from the circuit switch domain to the Internet Protocol network.

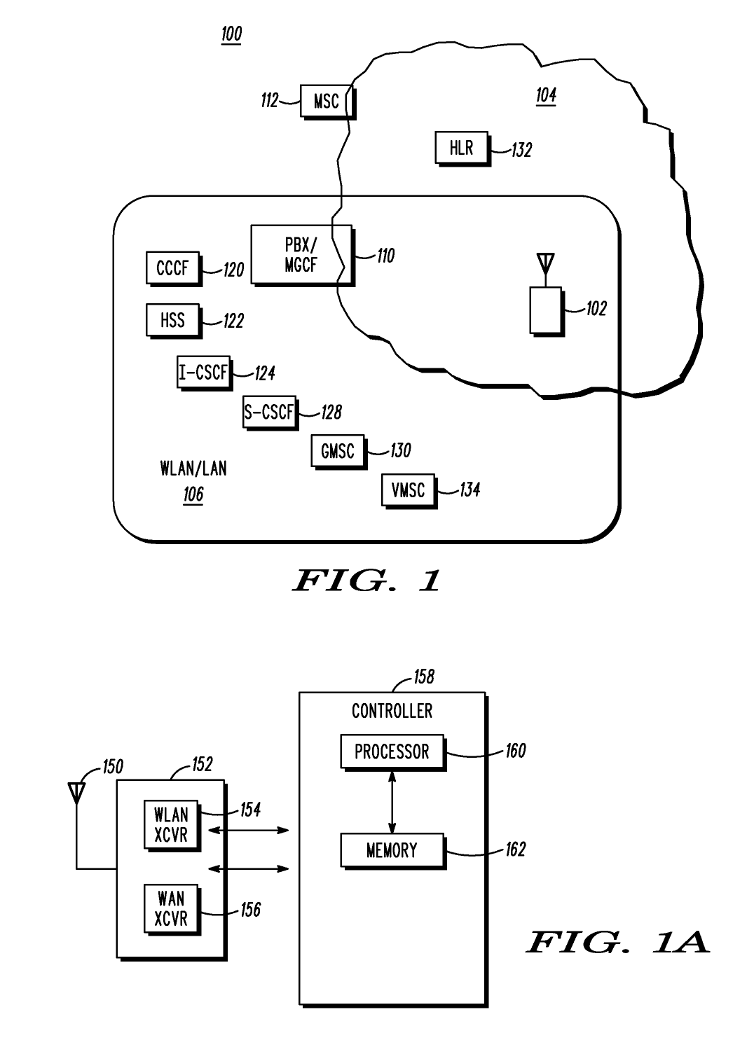

Referring to FIG. 1, a simplified and representative environment or system diagram where a call routing procedure within a wireless communication system 100 to the dual mode mobile station 102 can be implemented will be discussed and described. The diagram generally shows a mobile station 102 that is portable or mobile and that can be throughout a service area of a first wireless communication network 104 and a service area for a second wireless communication network 106. In one embodiment, the first network is a circuit switch domain network 104 and the second network is an IP domain network 106. The IP domain network 106 is or includes a wireless local area network (WLAN) or any type of 3^{rd} generation wireless communication network and the circuit switch domain network is or includes a cellular packet data network or other cellular or cellular like network otherwise referred to as a cellular wide area network (cellular WAN) or simply WAN. The IP network 106 includes a network switching function that may alternatively be referred to as Private Branch Exchange (PBX), enterprise server, media gateway control function (MGCF) 110 and so on. The circuit switch domain 104 includes a network switching function, alternatively referred to as a mobile switching center (MSC) 112. The coverage area of the circuit switch domain 104 is typically much larger than that of the first network and overlaps in total or in part the coverage area of the first network as depicted.

Also it will be appreciated that a large number of entities or functions that are part of typical networks are not specifically shown but understood to be present and operational. For example in the IP network 106 a large number of Access Points that support a radio or wireless link with a wireless communication unit and thereby couple the unit to the balance of the network are not shown as well as typical network routing equipment such as servers, concentrators, routers, etc. The circuit switch domain 104 similarly typically includes a plurality of base transmitters and antenna towers as well as base site controllers that all serve to provide a radio access network for communication units as well as various registrars, billing servers and so forth. Note that while the first and second networks 104, 106 are referred to as wireless networks, much of these networks or the respective elements thereof are intercoupled using terrestrial based wires. For example, the switching functions 110, 112 are normally coupled to the balance of their respective networks using ordinary cables or wires. Furthermore the IP network 106 can include and support voice services for stationary or static communications units that are coupled to the network using conventional cabling or wires. Thus the discussions below will refer alternatively to the IP network 106.

Both domains 104, 106 via the switching functions 110, 112 will likely be intercoupled to a public switched telephone and data network and thus coupled to each other. Furthermore the domains in an embodiment are packet data networks using packet switched methodologies. Furthermore the communication networks utilize some form of protocol for setting up sessions or connections with other units. Various known protocols can be used, such as H.323 defined and promulgated by the International Multimedia Telecommunication Consortium (IMTC) (see http://www.imtc.org/h323.htm and associated websites for descriptive documents) or Session Initiation Protocol (SIP) as defined by IETF in RFC3261 document. Much of the discussion below, where relevant will assume that SIP and SIP constructs and entities are being utilized in the WLAN and that legacy cellular or dispatch protocols are being utilized in the WAN, where it is understood that similar functions and methods are available using other protocols if desired.

The MGCF 110 may serve a single enterprise location, such as an office building or may serve multiple enterprise sites, possibly located in different cities. The MGCF 110 or enterprise server may serve a WLAN hotspot, or multiple WLAN hotspots. It may also serve one or more WLAN coverage areas in private homes that may be connected to the MGCF 110 by such means as IP broadband connections. Generally the network switching function operates to establish a connection between wireless communication units within the WLAN, such as mobile station 102.

In addition to the MGCF 110, the IP network 106 includes a call continuity control function (CCCF) 120 that operates to route and maintain calls that are sent to the dual mode mobile station 102. A home subscriber server (HSS) 122 is also provided in the IP network 106 together with an internet call session control function (I-CSCF) 124, and a serving call session control function (S-CSCF) 128. A gateway mobile switch center (GMSC) 130 can be provided as in interface between the circuit switch domain 104 and the IP network 106. An MGCF 110 can also be provided for the circuit switch domain if needed. In addition, a home location registry 132 is provided as is a VoIP mobile switching center (VMSC) 134. Those of ordinary skill in the art have knowledge as to the operation of the MGCF 110, CCCF 120, HSS 122, I-CSCF 124, S-CSCF 128, GMSC 130, HLR 132 and VMSC 134 for the use of these entities as a part of the present invention.

The mobile station 102 can be any type of mobile station 102 including a cellular phone, pager, personal digital assistant or other type of wireless device. To function in both the circuit switch domain 104 and the IP network 106, the mobile station 102 may be a dual mode mobile station that permits wireless communications in both domains. As will be appreciated by those of ordinary skill in the art, the mobile station 102 can be registered in either the circuit switch domain or the IP network or in both domains simultaneously. When the mobile station is registered in both domains, the present station provides a method for the call to be routed to the appropriate domain depending on defaults, operator policies and user preferences.

FIG. 1a is a simplified block diagram of a mobile station 102 that is arranged for facilitating the routing of calls to the mobile station 102 in the circuit switch domain or the IP network. The mobile station 102 is generally known. Thus the known functions and structure of such devices will not be described in detail other than as related to the inventive principles and concepts disclosed and discussed below. The mobile station 102 includes an antenna 150 or antenna structure that operates to couple radio frequency signals between a transceiver 152 and the first or second network 104, 106, as is known. For example, radio signals that are transmitted from the circuit switch domain 104 or the IP network 106, such as respectively, by an access point (WLAN transceiver) or base transmitter site (WAN transceiver) are absorbed by the antenna 150 and coupled to a receiver, that is part of the transceiver 152.

The transceiver 152 will be configurable to support simultaneous air interfaces with multiple communication networks according to the conventions and protocols of each or may alternatively further include one or more of a circuit switch domain transceiver 154 and an IP network transceiver 156 for such purposes as will be appreciated by those of ordinary skill. The transceiver 152 or respective receivers and transmitters are inter coupled as depicted and interactively operate with and are controlled by a controller 158 to provide to, or accept or receive from the controller 158, voice traffic or data messages or signals corresponding thereto in packet data form. Accordingly, the transceiver 152 as controlled by and in cooperation with the controller 158 and the functions thereof provides the mobile station 102 with multi or dual operating mode capability. More particularly, the mobile station 102 is capable of registering with and obtaining service from a circuit switch or IP network.

The controller 158 is essentially a general-purpose processor and, preferably, includes a processor 160 and an associated memory 162 The processor 160 is, preferably, a known processor based element with functionality that will depend on the specifics of the air interfaces with the first and the second network as well as various network protocols for voice and data traffic. The processor 160 will operate to encode and decode voice and data messages to provide signals suitable for the transceiver, a transducer, or further processing by the controller 158. The processor 160 may include one or more generally available microprocessors, digital signal processors, and other integrated circuits depending on the responsibilities of the controller 158 with respect to signal processing duties or other unit features that are not here relevant.

In any event the controller 158 also includes the memory 162 that may be, for example, a combination of known RAM (Random Access Memory), ROM (Read-Only Memory), EEPROM (Electrically Erasable Programmable ROM) or magnetic memory. The memory 162 is used to store among various other items or programs etc., an operating system or software, data, and variables for execution or use by the processor 160. This operating software when executed by the processor will result in the processor performing the requisite functions of the mobile station 102. The memory 162 further includes call processing routines not specifically shown for supporting voice and data calls that will be appreciated by one of ordinary skill and that will vary depending on air interface, call processing, and service provider or network specifics.

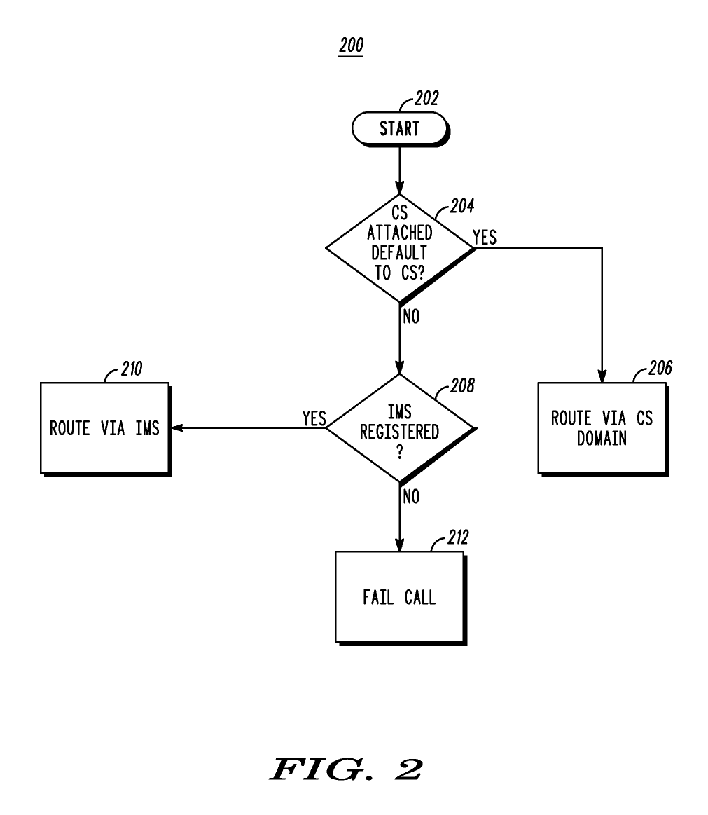

In FIG. 2, the routing selection for the mobile station 102 is shown when the default domain of the mobile station 102 is in the circuit switch domain 104. In the first case, when the mobile station 102 is attached to the circuit switch domain and there is circuit switch coverage for the mobile station 102, an incoming call is routed to the mobile station 102 via the circuit switch domain 104. In another case, the mobile station is attached to the circuit switch domain 104 and is IMS registered but there is no circuit switch coverage. In this situation, an attempt is made to route the call to the circuit switch domain 104, but the call may fail because the phone is not registered in that domain but may be redirected. The call may not be able to be routed to the IP network 106 because there is no correlation between the circuit switch domain 104 and the IMS registration to inform the IP network 106 that circuit switch call has filed.

When the mobile station 102 is not attached to the circuit switch domain 104 and is IMS registered, there still may be coverage such that the call may be delivered in the IP network 106. An attempt will be made to via the IP network. If there is coverage, then the delivery in the IP network will succeed. If there is no coverage, the call may fail.

The routing of the call 200 when the mobile station 102 is in the circuit switch network 104 will start 202 with the dual mode mobiles station 102 being dual subscribed to the circuit switch domain 104 and the IP network 106. It will be determined 204 if the mobile station is circuit switch domain attached and if the default is for the circuit switch domain 104. If so, the call is routed 206 via the circuit switch domain. If the call is not defaulted to the circuit switch network, it is determined 208 if the mobile station is IMS registered. If the mobile station is IMS registered, then the call is routed 210 via IMS to the IP network. If the phone is not IMS registered then the call may fail but may be redirected.

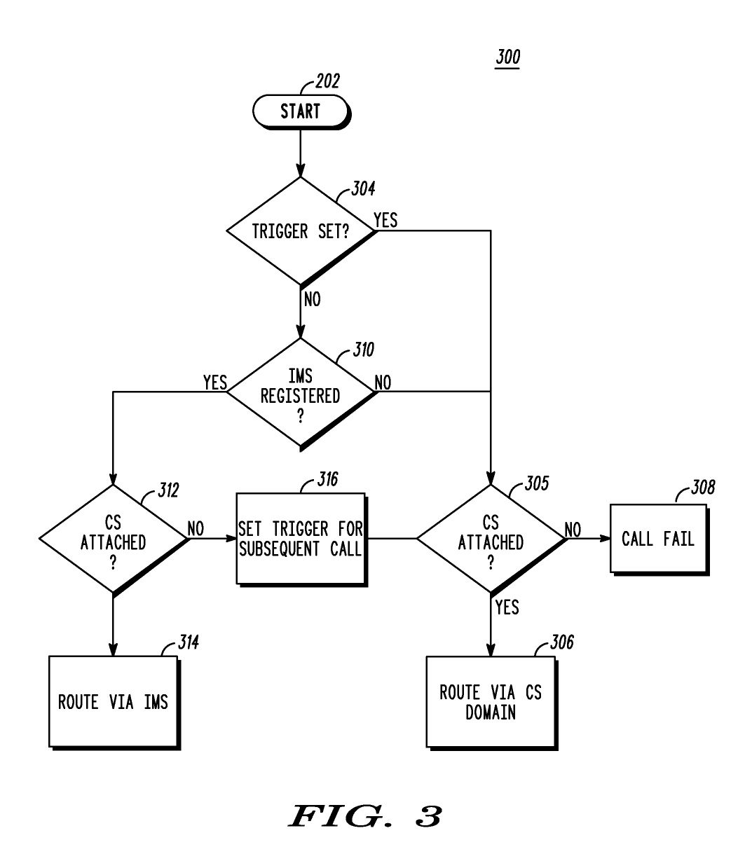

In FIG. 3, a flow chart for the routing of a call when the default domain is in the IP network. The principles followed for this situation are described. If the mobile station 102 is IMS registered and there is IP network coverage then an attempt to deliver the call via the IP network is made. If, on the other hand, the phone is attached to the circuit switch domain and is IMS registered without an IP network 106 coverage, an attempt to make the call via the IP network is made. The call will fail, so an attempt will be made to deliver the call via the circuit switch domain 104. Subsequent calls will be routed via the circuit switch domain until a time expires or the mobile station is re-registered in IMS. If the mobile station 102 is not circuit switch attached and is IMS registered but there is no IP coverage, the call will attempt to be delivered via the IP network 106. When the mobile station is not circuit switch attached or IMS registered, then the call may fail until the call can be redirected. When the mobile station is circuit switch attached but not IMS registered, then the call is routed to the circuit switch domain.

The routing 300 of the call will start 302 with the mobile station have subscriptions to both the circuit switch domain 104 and the IP network 106. A determination is made 304 if a trigger is set. The trigger indicates whether previous calls have sent via the IP network 106 or the circuit switch domain 104. If the trigger is set, it is determined 305 if the mobile station is attached to the circuit switch domain 104. If the circuit switch domain 104 is available, then the call is routed 306 to that domain. If the circuit switch domain 104 is not available, then the call may fail 308 but may be redirected.

Returning to the examination of the trigger, it is determined 310 if the mobile station 102 is IMS registered. If there is that registration, then it is determined 312 if the mobile station 102 is in the IP network and there is IP coverage. If there is IP network 106 coverage, then the call is routed 314 via the IP network. If there is no IP coverage, the trigger is set 316 to route subsequent calls to the circuit switch domain. The process then returns to step 306 to determine if the phone is attached to the circuit switch domain 104. Once the trigger is set at 314, the trigger can be cleared after the expiration of a timer. The trigger can also be cleared when the phone IMS registered IP network when the phone moves from a circuit switch domain 104 to an IP network 106.

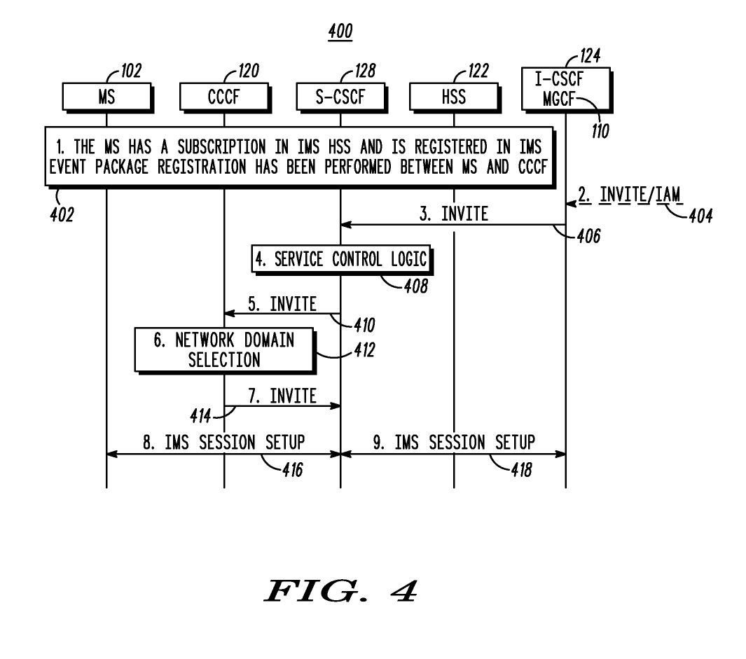

FIG. 4 illustrates a call flow diagram 400 when the dual mode mobile station 102 has an IMS-based telephone number and the call is to be routed to the IP network. In this illustration, the mobile station 102 has either registered only in the IP network or is registered in both the circuit switch domain and the IP network and a call continuity control function (CCCF) 120 determines that the call should be routed via the IP network. Registration includes the subscription to the mobility event package for voice calls. As seen, the process 400 begins 402 such that mobile station has subscription in the IMS home subscriber server (HSS) 122 and is registered in IMS. Event package registration has been performed between the mobile station and the CCCF. The originating network sends 404 an Invite request to the IMS call session control function (I-CSCF) 124 for an IMS incoming call and media gateway control function 110 for a circuit switch incoming call. The Invite request is then sent 406 directly to the serving call session control function (S-CSCF) 128 for the mobile station 102 that the call is being routed to according to known serving to serving-CSCF procedures.

The S-CSCF 128 then validates 408 the profile of the mobile station 102. After validation, the S-CSCF 128 invites 410 the CCCF 120 as a part of the termination service logic required for the user making the call being routed. At 412, the CCCF 120 determines that the call is to be routed to the IP network 106 and send 414 an invite message back to the S-CSCF 128 indicating the IP network will be used. The S-CSCF 128 then sets up 416 the IMS session between the S-CSCF 128 and the mobile station 102 and sets up 419 the IMS session between the S-CSCF 128 and the I-CSCF and MGCF an onto the device making the originating call.

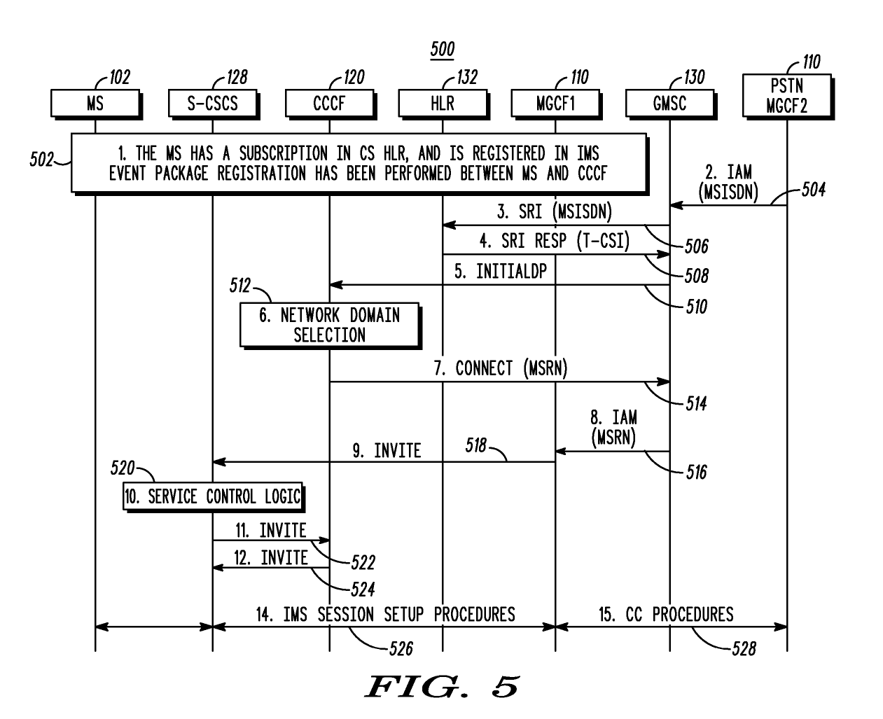

Turning to FIG. 5, a call flow diagram 500 is shown that applies to the dual registration in the circuit switch domain 104 and the IP network 104 with circuit switch domain coverage. Similar to above, the mobile station 102 has either registered only in the IP network or is registered in both the circuit switch domain and the IP network and a call continuity control function (CCCF) 120 determines that the call should be routed via the IP network. When the GMSC 130 receives the incoming call request, it contacts the CCCF 120, which determines that the call should be routed to in the IP network and provides the GMSC with the mobile subscriber routing number (MSRN) towards the IP network. To begin 502, the mobile station 102 has a subscription with the circuit switch home location registry (HLR) 132 and is registered in the IP network. The mobile station 102 and the CCCF 120 have therefore both registered an event package with one another.

The originating network, which is where the call being routed according to this process is coming from, sends 504 a message for an initial address using a mobile subscriber ISDN from the MGCF 110 for an IMS call or from another circuit switch domain to the GMSC 130. The GMSC 130 requests 506 a send routing information message from the HLR 132. The HLR 132 responds 508 with terminal channel state information to the GMSC 130 to trigger dialog 510 between the GMSC 130 and the CCCF 120 such as customized application for mobile enhanced logic (CAMEL). The CCCF 120 determines 512 that the call may be routed via the IP network. The CCCF 120 then returns 514 an MSRN to the GMSC 130 pointing the MGCF 110. This is done using the connect operation to route the call in the IP network 106. The GMSC 130 then forwards 516 the message for the initial address to the MGCF 110 for the IP network, which acts as a terminating VoIP mobile switching center (VMSC). The MGCF 110 resolves the MSRN for the mobile station 102 and sends 518 an invite to the S-CSCF 128. The S-CSCF 128 validates a profile and invokes 520 the CCCF 120 as part of the termination service logic required by the mobile station 102. Thus, the CCCF 120 responds 522 to the S-CSCF 128. The S-CSCF 128 then sets up 524 the IMS session between the S-CSCF 128 and the mobile station 102 and sets up 526 the IMS session between the S-CSCF 128 and the I-CSCF and MGCF an onto the device making the originating call. The MGCF 110 translates the results to circuit switch signaling as per usual procedures.

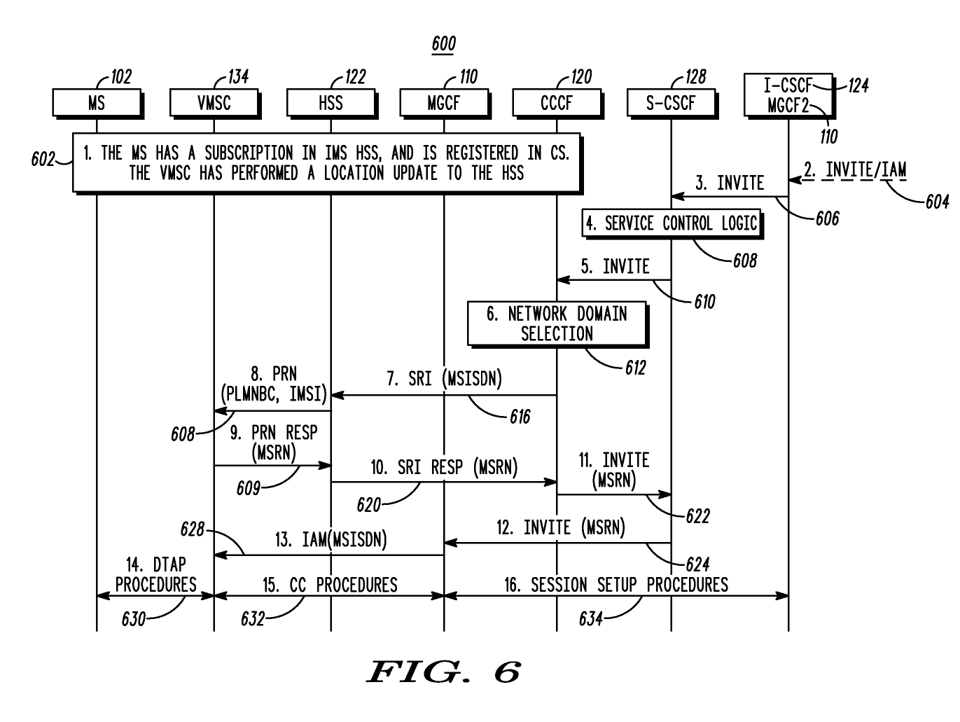

FIG. 6 illustrates the call flow 600 for a dual mode mobile station 102 that is registered to the circuit switch domain when there is no IP coverage and where the incoming call from the IP network is routed to the serving CSCF via an I-CSCF. To begin 602, the mobile station 102 subscription is stored in the HSS 122 of the IP network. The mobile station is also registered with circuit switch domain 104. The VMSC 134 has also performed a location update to the HSS 122. When a call is to be routed to the mobile station 102, the originating network sends 604 a message to the IMS CSCF and message to the MGCF for the circuit domain. The message is sent 606 to the S-CSCF for the mobile station 102 according to known procedures. The S-CSCF validates 608 the service profile and then invokes 610 the CCCF 120 as part of the termination service logic required for the mobile station 102.

The CCCF 120 determines 612 that the call should be set up in the circuit switch domain 104 because the IP network is not available. As such, the CCCF 120 queries 616 the HSS 122 for a mobile subscriber routing number to identify the mobile station 102. In response to the query, the HSS 122 queries 618 the VMSC 134 for the MSRN for the mobile station 102. Once the HSS 122 has the MSRN, the identifier is sent 620 to the CCCF 120. The CCCF 120 responds 622 to the S-CSCF 128 with the MSRN so that the S-CSCF 128 sends 624 the message to the MGCF for the circuit switch domain to enter the circuit switch domain. The MGCF initiates 628 a message for an initial address with the VMSC 134 such that the VMSC 134 follows 630 standard procedures with the mobile station 102. In addition, the MGCF initiates 632 call set-up procedures with the VMSC and session set up procedures 634 with the I-CSCF.

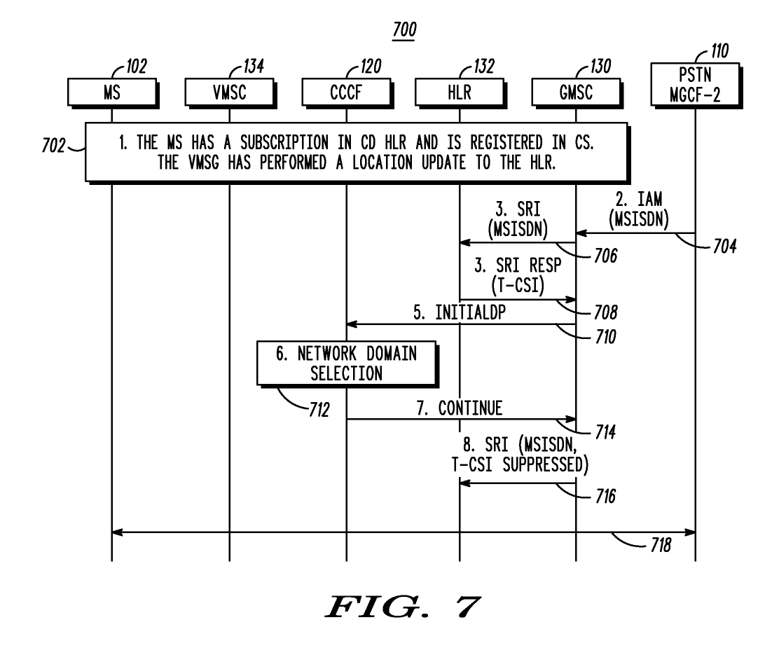

Focusing on FIG. 7, a call flow 700 for a dual mode mobile station 102 that is registered in and has coverage in the circuit switch domain is shown. To begin 702, the mobile station that is to have a call routed to it is registered with the circuit switch domain HLR. The VMSC 134 has also performed a location update with the HLR. The originating network sends 704 a message to the circuit switch domain GMSC 130. This message is sent from the MGCF for an IMS originating call or from another circuit switch network. The GMSC 130 sends 706 routing information to the HLR. The HLR responses 708 with terminal channel state information to the GMSC 130 trigger a CAMEL dialog with the CCCF. With the trigger, the CCCF 120 initiates 710 the CAMEL dialog with the CCCF 120. The CCCF 120 then determines 712 that the call shall be routed via the circuit switch domain 104. Since the call will be in this domain, the CCF returns 714 a message indicating the decision to the GMSC 130.

With the knowledge that the call will be routed in the circuit switch domain 104, the GMSC 130 queries 716 the HLR once again to suppress the terminal channel state information. Normal circuit switch domain call set up procedures are then followed 718.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method of routing a call to a dual mode mobile station when the dual mode mobile station is in at least one of a plurality of domains and the mobile station has a default domain to which a call will be routed comprising:
delivering the call to the domain in which the mobile station has coverage when the default domain of the mobile station is compatible with the domain in which the mobile station has coverage;
failing the call in the first domain when the mobile station is in a first domain of the at least one of a plurality of domains, is registered in a second domain of the at least one of a plurality of domains and there is no coverage in the second domain; and
delivering the call to the second domain when the mobile station is not in the first domain, is registered in the second domain and there is coverage in the second domain.

2. The method according to claim 1 further comprising failing the call in the first domain and the second domain when the mobile station is not in the first domain and is not registered in the second domain.

3. The method according to claim 1 wherein failing the call in the first domain when the mobile station is in a first domain of the at least one of a plurality of domains, is registered in a second domain of the at least one of a plurality of domains and there is no coverage in the second domain further comprising delivering the call to the first domain when there is coverage in the first domain.

4. The method according to claim 1 wherein the first domain is a circuit switch domain.

5. The method according to claim 1 wherein the second domain is an Internet Protocol network.

6. The method according to claim 5 wherein access is provided to the Internet Protocol network from among one of wireless communication network, fixed connections or cable networks.

7. The method according to claim 6 wherein the default domain and the first domain is a circuit switch domain.

8. The method according to claim 6 wherein the default domain and the second domain is an Internet Protocol network.

9. A method of routing a call to a dual mode mobile station wherein the dual mode mobile station is in a circuit switch domain and can be registered in a Internet Protocol network comprising:
delivering the call via the circuit switch domain when the mobile station is attached to the circuit switch domain and is in circuit switch coverage; and
delivering the call via the Internet Protocol Network when the mobile station is registered with an Internet Protocol Multimedia Subsystem and is in the Internet Protocol network.

10. The method according to claim 9 further comprising:
failing to deliver the call when the mobile station is registered with an Internet Protocol Multimedia Subsystem and the mobile station is not in the Internet Protocol network.

11. The method according to claim 10 wherein the mobile station is not in the circuit switch domain.

12. The method according to claim 9 further comprising:
failing to deliver the call when the mobile station is not in the circuit switch domain and the mobile station is not registered with the Internet Protocol Multimedia Subsystem.

13. A method of routing a call to a dual mode mobile station wherein the mobile station has a default domain set to the Internet Protocol Multimedia Subsystem comprising:
delivering the call to the Internet Protocol network when the mobile station is registered with an Internet Protocol Multimedia Subsystem and has coverage in Internet Protocol network;
delivering the call to a circuit switch domain when the mobile station is registered with an Internet Protocol Multimedia Subsystem, the mobile station is in the circuit switch domain and there is no coverage Internet Protocol network, and
delivering the call to a circuit switch domain when the mobile station is not registered with the Internet Protocol Multimedia Subsystem and the mobile station is in the circuit switch domain.

14. The method according to claim 13 further comprising:
delivering a subsequent call to the circuit switch domain after the call is delivered to the circuit switch domain when the mobile station is dual registered with the Internet Protocol Multimedia Subsystem and the circuit switch domain and the mobile station is in the circuit switch domain.

15. The method according to claim 14 further comprising:
delivering a subsequent call to the Internet Protocol network when after the call is delivered to the circuit switch domain when the mobile station is registered with an Internet Protocol Multimedia Subsystem and the mobile station is in the circuit switch domain when the mobile station moves from the circuit switch domain to the Internet Protocol network.

16. The method according to claim 14 further comprising:
delivering a subsequent call to the Internet Protocol network when after the call is delivered to the circuit switch domain when the mobile station is registered with an Internet Protocol Multimedia Subsystem and the mobile station is in the circuit switch domain when a timer expires.

17. The method according to claim 13 further comprising:
delivering a subsequent call to the Internet Protocol network when after the call is delivered to the circuit switch domain when the mobile station is registered with an Internet Protocol Multimedia Subsystem and the mobile station is in the circuit switch domain when the mobile station moves from the circuit switch domain to the Internet Protocol network.

18. The method according to claim 13 further comprising:
delivering a subsequent call to the Internet Protocol network when after the call is delivered to the circuit switch domain when the mobile station is registered with an Internet Protocol Multimedia Subsystem and the mobile station is in the circuit switch domain when a timer expires.

19. The method according to claim 13 wherein delivering the call to a circuit switch domain when the mobile station is registered with an Internet Protocol Multimedia Subsystem, the mobile station is in the circuit switch domain and there is no coverage Internet Protocol network further comprising setting a timer when delivering to the Internet Protocol network failed due to lack of coverage of the Internet Protocol network.

20. The method according to claim 19 further comprising delivering subsequent calls to the circuit switch domain until the timer expires or the mobile station is registered with the Internet Protocol Multimedia Subsystem and the mobile station is in the circuit domain.
